(19) United States
(12) Patent Application Publication
(10) Pub. No.: US 2026/0161360 A1
(43) Pub. Date: Jun. 11, 2026

(54) SECURITY MANAGEMENT DEVICE FOR MOBILE TERMINALS BASED ON QUANTUM RANDOM NUMBERS

(71) Applicant: MDS Tech Inc., Seongnam-si Gyeonggi-do (KR)

(72) Inventors: Hyosoung LEE, Seongnam-si Gyeonggi-do (KR); JungMin LEE, Seoul (KR); JuneHo PARK, Hanam-si Gyeonggi-do (KR)

(73) Assignee: MDS Tech Inc., Seongnam-si Gyeonggi-do (KR)

(21) Appl. No.: 19/366,783

(22) Filed: Oct. 23, 2025

(30) Foreign Application Priority Data
Dec. 5, 2024 (KR) 10-2024-0179049

(51) Int. Cl. G06F 7/58; H04L 9/08

(52) U.S. Cl. CPC G06F 7/588; H04L 9/0852

(57) ABSTRACT

The present disclosure relates to a security management device for mobile terminals based on quantum random numbers and a security management method for mobile terminals based on quantum random numbers for supporting authentication and identification of communication devices and safely transmitting/receiving and managing data through a hardware-based quantum security module. It is possible to prevent security vulnerabilities that may arise during communication by using the quantum random numbers generated by the first quantum random number generation unit and the second quantum random number generation unit, and by allowing the communication unit to encrypt the user communication data based on the authentication value generated by the quantum security module, it is possible to implement the safe data transmission. By allowing the communication module to verify the devices and the user authentication information in real time, it is possible to prevent the data leakage and unauthorized access on the network.

### CROSS-REFERENCE TO RELATED APPLICATIONS

This application claims priority to Korean Patent Application No. 10-2024-0179049 filed on Dec. 5, 2024, the entire contents of which are herein incorporated by reference.

This work was supported by the Institute of Information & Communications Technology Planning & Evaluation (IITP) grant funded by the Korea government (MSIT) (RS-2024-00438156, Development of security resilience technology based on network slicing service in the 5G specialized network).

### BACKGROUND

### 1. Field

The present disclosure relates to a security management device for mobile terminals based on quantum random numbers, and more particularly, to a security management device for mobile terminals based on quantum random numbers and a security management method for mobile terminals based on quantum random numbers for supporting authentication and identification of communication devices and safely transmitting/receiving and managing data through a hardware-based quantum security module connected to each communication device.

### 2. Description of Related Art

Communication devices are electronic devices that are connected to a network and operate autonomously or interdependently. A smart device is an information device that is not bound by the framework of the traditional computer, and does not have limited functions. Their functions may be significantly modified or expanded through application programs. A type of communication devices may typically include smartphones, but are not limited thereto, and may include various terminal devices such as a tablet PC, a smart video playback device, a smart video generation device, a smart video collector, as well as audio devices, healthcare devices, video devices, and driving devices that utilize various communication technologies (e.g., Wi-Fi, Bluetooth, LTE, etc.).

Communication devices for the military, public, and private Internet of Things (IoT) environments require identification and authentication of both devices for two-way communication with a higher-level system and a central system, as well as reliable data transmission.

Quantum security is a technology that uses a “quantum random number generator (QRNG)” to generate unpredictable, pattern-free, true random numbers, thereby preventing duplication⋅prediction of encryption keys. The randomness of the QRNG is higher than that of ‘true random number generator (TRNG)’ which is a security technology used in the existing IoT devices, thereby making the IoT devices safe from hacking threats. The QRNG provides approximately 26% higher randomness than the TRNG. This allows customers to prevent privacy violations and information leaks.

The random number refers to a number without a specific order or pattern. In English, it is called a “random number.” It is very important to generate the random numbers. The random numbers are used for sampling in surveys, generating passwords, and inspecting defect rates in manufacturing.

For example, since surveys cannot be conducted on the entire population, thousands of people are randomly selected. For a reliable survey, the sample should be completely free of bias. A sample with a high proportion of supporters of a particular political party or a biased sample in a particular region may significantly undermine reliability. In such cases, the technology to truly “randomly” select a sample is crucial. Many people believe that generating random numbers is easy because random numbers themselves are not a difficult concept. However, generating the random numbers is never simple. Of course, people may easily and unconsciously generate random numbers. The problem lies with computers. Given the hundreds of random numbers required, it is impossible for a human to generate the random number one by one.

Meanwhile, the above-described background art is technical information retained by the inventor to derive the present disclosure or acquired by the inventor while deriving the present disclosure, and thus should not be construed as art that was publicly known prior to the filing date of the present disclosure.

### RELATED ART DOCUMENT

### Patent Document

(Patent Document 0001) Korean Patent No. 10-1918973 (Nov. 9, 2018)
(Patent Document 0002) Korean Patent No. 10-2018-0136628 (Dec. 26, 2018)

### SUMMARY

An aspect of the present disclosure provides a security management device for mobile terminals based on quantum random numbers, which uses a hardware-based quantum security module to enhance the security management of 5G specialized network communication devices.

Another aspect of the present disclosure is to manage the security of a communication device through mutual authentication between a communication device and a hardware-based quantum security module.

Technical problems of the present disclosure are not limited to the above-mentioned objects. That is, other technical problems that are not mentioned may be obviously understood by those skilled in the art from the following description.

The solution of the present disclosure for solving the above-mentioned problems is as follows.

According to a first aspect, a security management device for mobile terminals based on quantum random numbers includes: a first quantum security module (100) connected to a first communication device (200) to support cryptographic secure communication of the first communication device (200); the first communication device (200), and a network (300) transmitting user data input from the first communication device (200) to the first quantum security module (100).

The first quantum security module (100) may include: a first communication unit (110) transmitting and receiving data to and from the first communication device (200); a first quantum random number generation unit (120) generating quantum random numbers required in a quantum security encryption process for quantum encryption of processing data requested from the first communication device (200); a first operation unit (130) performing a quantum security operation on the processing data requested from the first communication device (200) using an initial seed key when the hardware-based quantum security module is called from the first communication device (200), and performing a general encryption operation; a second operation unit (140) performing the quantum security operation on the processing data requested from the first communication device using the initial seed key when the hardware-based quantum security module is called from the first communication device, and performing the quantum encryption operation; a first authentication unit (150) receiving user operation data and generating an authentication value; and a first erasure unit (160) erasing an encryption key; and a first security data unit (170) storing the initial seed key.

The first communication device (200) may include: a first external communication unit (210) enabling communication via the network (300); a first device authentication unit (220) authenticating a user based on pre-stored user authentication information; a first internal communication unit (230) enabling communication with the first quantum security module (300); and a first application (240) performing authentication via the first quantum security module (300).

The first quantum random number generation unit (120) may be implemented in a chip form and perform cryptographic algorithm processing using alpha (α), beta (β), or gamma (γ) particles emitted from a radioactive isotope as a noise source to generate the quantum random numbers.

The first quantum random number generation unit (120) may set, as variables, environmental information measured at a time when the first communication device requests data processing and information on the time when the first communication device requests the data processing, and calculate the set variables to derive the quantum random numbers.

According to a second aspect, a security management device for mobile terminals based on quantum random numbers includes: a first quantum security module (100) connected to a first communication device (200) to support cryptographic secure communication of the first communication device (200); the first communication device (200); and a network (300) transmitting user data input from the first communication device (200) to the first quantum security module (100) and transmitting user data input from a second communication device (500) to a second quantum security module (400); the second security module 400 connected to the second communication device 500 to support the cryptographic secure communication of the second communication device 500; and the second communication device (500).

The first quantum security module (100) may include: a first communication unit (110) transmitting and receiving data to and from the first communication device (200); a first quantum random number generation unit (120) generating quantum random numbers required in a quantum security encryption process for quantum encryption of processing data requested from the first communication device (200); a first operation unit (130) performing a quantum security operation on the processing data requested from the first communication device (200) using an initial seed key when the hardware-based quantum security module is called from the first communication device (200), and performing a general encryption operation; a second operation unit (140) performing the quantum security operation on the processing data requested from the first communication device using the initial seed key when the hardware-based quantum security module is called from the first communication device, and performing the quantum encryption operation; a first authentication unit (150) receiving user operation data and generating an authentication value; and a first security data unit (170) storing the initial seed key.

The first quantum random number generation unit (120) may set, as variables, environmental information measured at a time when the first communication device requests data processing and information on the time when the first communication device requests the data processing, and calculate the set variables to derive the quantum random numbers.

The first communication device (200) may include: a first external communication unit (210) enabling communication via the network (300); a first device authentication unit (220) authenticating a user based on pre-stored user authentication information; a first internal communication unit (230) enabling communication with the first quantum security module (300); and a first application (240) performing authentication via the first quantum security module (300).

The first quantum random number generation unit (120) may be implemented in a chip form and perform cryptographic algorithm processing using alpha (α), beta (β), or gamma (γ) particles emitted from a radioactive isotope as a noise source to generate the quantum random numbers.

The quantum random numbers may be proportional to a summed value of temperature measured at a time when the first communication device requests data processing, humidity measured at the time when the first communication device requests the data processing, and atmospheric pressure measured at the time when the first communication device requests the data processing.

According to a third aspect, a security management method for mobile terminals based on quantum random numbers is as follows.

There is provided a security management method for mobile terminals based on quantum random numbers, including: a transmission step to a first communication device (S12) of transmitting input user data to a first communication device (200); a first communication device authentication step (S13) of authenticating user data through a first device authentication unit (220) and a first internal communication unit (230) included in the first communication device (200); a transmission step to a first quantum security module unit (S14) of transmitting the user data from a first internal communication unit (230) included in the first communication device (200) to a first quantum security module unit via a first communication unit (110) of a first quantum security module (100); a first quantum security module unit authentication step (S15) of transmitting the user data to a first authentication unit (150) included in the first quantum security module (100); a first authentication value generation step (S16) of generating an authentication value for the user data transmitted through the first quantum security module unit authentication step (S5); and a first authentication value confirmation and connection step (S17) of confirming an authentication value generated through a first authentication value generation step (S6) and connecting the first communication device (200).

In the security management method for mobile terminals based on quantum random numbers, the first quantum security module (100) may include: a first communication unit (110) transmitting and receiving data to and from the first communication device (200); and a first quantum random number generation unit (120) generating quantum random numbers required in a quantum security encryption process for quantum encryption of processing data requested from the first communication device (200), in which the first quantum random number generation unit (120) may set, as variables, environmental information measured at a time when the first communication device requests data processing and information on the time when the first communication device requests the data processing, and calculate the set variables to derive the quantum random numbers.

According to a fourth aspect, a method for generating a seed value stored in a security data storage unit is as follows.

The method for generating a seed value stored in a security data storage unit may include: receiving power from the first communication device (200); receiving initial power, and then generating a seed value for only a first quantum security module (100), the seed value being generated through a seed generation server of the hardware-based first quantum security module (100); and storing the generated seed value in a first security data unit (170) included in the first quantum security module (100).

In the method for generating a seed value stored in a security data storage unit, the first quantum security module (100) may include: a first communication unit (110) transmitting and receiving data to and from the first communication device (200); and a first quantum random number generation unit (120) generating quantum random numbers required in a quantum security encryption process for quantum encryption of processing data requested from the first communication device (200), in which the first quantum random number generation unit (120) may include a first security data unit (170) for storing the initial seed key, and set, as variables, environmental information measured at a time when the first communication device requests data processing and information on the time when the first communication device requests the data processing, and calculate the set variables to derive the quantum random numbers.

The above problems are solved by the means of the present disclosure as described.

### BRIEF DESCRIPTION OF DRAWINGS

FIG. 1 is a diagram schematically illustrating the overall configuration of the present disclosure.

FIG. 2 is a diagram illustrating an embodiment of the overall configuration of the present disclosure.

FIG. 3 is a configuration diagram of a first quantum security module 100 of the present disclosure.

FIG. 4 is a diagram illustrating communication between a first communication unit 110 of the first quantum security module 100 of the present disclosure and a first internal communication unit 230 of a first communication device 200.

FIG. 5 is an exemplary diagram illustrating communication between a quantum security module of the present disclosure and a communication device.

FIG. 6 is an exemplary diagram illustrating the generation of a seed key in security data storage of the present disclosure.

FIG. 7 is a configuration diagram of the first communication device 200 of the present disclosure.

FIG. 8 is an exemplary diagram of authentication between a first device authentication unit 220 and a first application 240 as an example of the first communication device 200 of the present disclosure.

FIG. 9 is an exemplary diagram of authentication between the first device authentication unit 220 and a second application 250 as an example of the first communication device 200 of the present disclosure.

FIG. 10 is a configuration diagram of a second quantum security module 400 of the present disclosure.

FIG. 11 is a diagram illustrating communication between a second communication unit 410 of the second quantum security module 400 of the present disclosure and a second internal communication unit 530 of a second communication device 500.

FIG. 12 is a configuration diagram of the second communication device 500 of the present disclosure.

FIG. 13 is an exemplary diagram of authentication between a second authentication unit 520 and a third application 540 as an example of the second communication device 500 of the present disclosure.

FIG. 14 is an exemplary diagram of authentication between the second authentication unit 520 and a fourth application 550 as an example of the second communication device 500 of the present disclosure.

FIG. 15 is a diagram illustrating a communication state between an external communication unit and a network (5G specialized network) of the first communication device 200 of the present disclosure and a communication state between an external communication unit and a network (5G specialized network) of the second communication device 500.

FIG. 16 is a flowchart of a method for generating a seed value stored in a first security data storage unit of the present disclosure.

FIG. 17 is a flowchart of a method for generating a seed value stored in a second security data storage unit of the present disclosure.

FIG. 18 is an exemplary flowchart for performing authentication of user data transmitted through the first communication device of the present disclosure through a quantum security module unit.

FIG. 19 is an exemplary flowchart for performing authentication of user data transmitted through the second communication device of the present disclosure through the quantum security module unit.

FIG. 20 is an exemplary flowchart for performing a quantum security operation of the present disclosure.

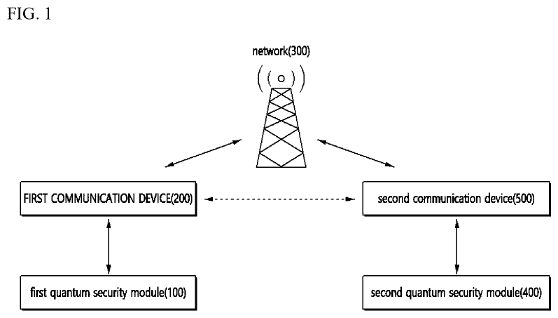

### DETAILED DESCRIPTION

The detailed description of the present disclosure set forth below refers to the accompanying drawings, which show by way of illustration specific embodiments in which the invention may be practiced. These embodiments will be described in detail for those skilled in the art in order to practice the present disclosure. It should be appreciated that various exemplary embodiments of the present disclosure are different from each other, but do not have to be exclusive. For example, specific shapes, structures, and characteristics described in the present specification may be implemented in another exemplary embodiment without departing from the spirit and the scope of the present disclosure in connection with an exemplary embodiment. In addition, it should be understood that a position or an arrangement of individual components in each disclosed exemplary embodiment may be changed without departing from the spirit and the scope of the present disclosure. Therefore, a detailed description described below should not be construed as being restrictive. In addition, the scope of the present disclosure is defined only by the accompanying claims and their equivalents if appropriate. Similar reference numerals will be used to describe the same or similar functions throughout the accompanying drawings.

Hereinafter, preferred embodiments of the present disclosure will be described in more detail with reference to the accompanying drawings.

The present disclosure relates to a security management device for mobile terminals based on quantum random numbers, and more particularly, to a security management device for mobile terminals based on quantum random numbers and a security management method for mobile terminals based on quantum random numbers for supporting authentication and identification of communication devices and safely transmitting/receiving and managing data through a hardware-based quantum security module connected to each communication device.

The present disclosure is to provide a security management device for mobile terminals based on quantum random numbers, which uses a hardware-based quantum security module to enhance security management of 5G specialized network communication devices. In addition, the present disclosure is to manage the security of a communication device through mutual authentication between a communication device and a hardware-based quantum security module.

To this end, a communication device, a base station, and an operation server may be interconnected via a network via wireless communication such as satellite communication, 4G, 5G, 6G, WiFi, or TVWS, or wired communication such as Ethernet or serial communication. For convenience of description, the present disclosure will be described under the assumption that data is transmitted and received via a 5G specialized network.

The communication device may be implemented in various forms and may be an electronic device such as a smartphone, a PC, a tablet PC, or a wearable device capable of wired or wireless communication with external devices and data input/output and processing.

The hardware-based quantum security module of the present disclosure may be connected to the communication device to support cryptographic secure communication of the communication device.

In an embodiment, the hardware-based quantum security module may be implemented as a separate, independent unit to be detachably connected to the communication device in an external form, but is not limited thereto, and the hardware-based quantum security module may also be implemented within the communication device.

That is, the present disclosure relates to a security management device for mobile terminals based on quantum random numbers. The security management device includes a first quantum security module 100 connected to a first communication device 200 to support cryptographic secure communication of the first communication device 200, the first communication device 200, a network 300 transmitting user data input from the first communication device 200 to the first quantum security module 100 and transmitting user data input from a second communication device 500 to the second quantum security module 400, a second quantum security module 400 connected to the second communication device 500 to support the cryptographic secure communication of the second communication device 500, and the second communication device, in which the first communication device 200 transmits and receives data via the network 300, the second device transmits and receives data via the network 300.

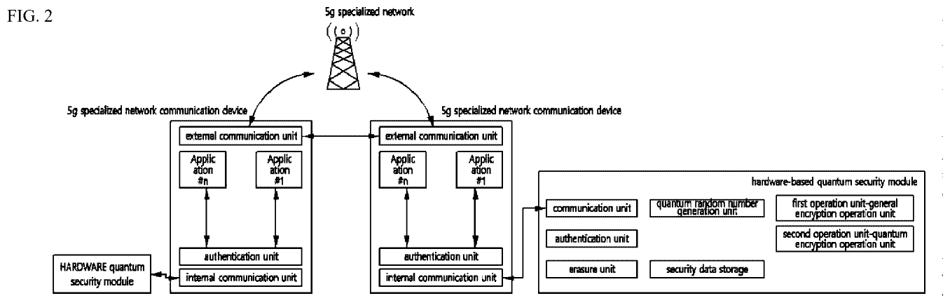

FIG. 2 is a diagram illustrating a specific configuration of an embodiment of the first quantum security module 100, the first communication device 200, the network 300, the second quantum security module 400, and the second communication device 500.

Each detailed configuration is described below.

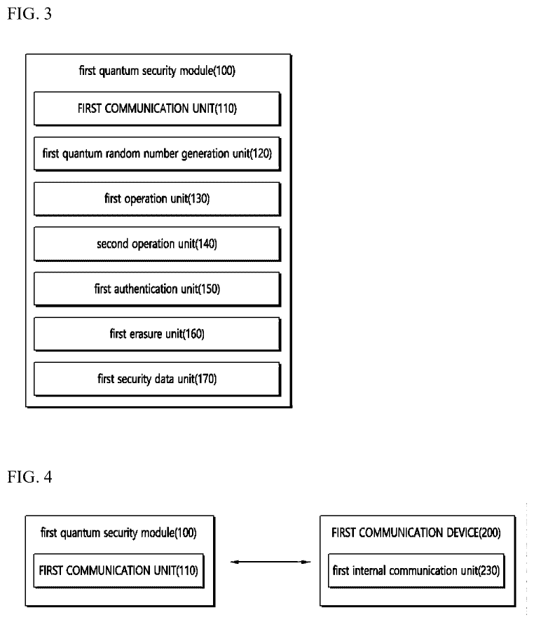

FIG. 3 is a configuration diagram of the first quantum security module 100 of the present disclosure. The first quantum security module 100 includes a first communication unit 110, a first quantum random number generation unit 120, a first operation unit 130, a second operation unit 140, a first authentication unit 150, a first erasure unit 160, and a first security data unit 170. The first quantum security module 100 may include a hardware processor and a memory. Each of the first communication unit 110, the first quantum random number generation unit 120, the first operation unit 130, the second operation unit 140, the first authentication unit 150, the first erasure unit 160, and the first security data unit 170 may be a part of the hardware processor or a software module stored in the module and executed by the hardware processor.

The first communication unit 110 is for transmitting and receiving data to and from the first communication device 200.

The first quantum random number generation unit 120 generates quantum random numbers required in the quantum security encryption process for quantum encryption of processing data requested from the first communication device 200.

The quantum random numbers are a technology that generates high-quality, random and unpredictable random numbers by using irregularities occurring in quantum phenomena. A quantum random number generation method may be classified into a method that uses randomness of light (photons) and a method that uses radioactive isotopes.

The first quantum random number generation unit 120 may be implemented in a chip form and perform cryptographic algorithm processing using alpha (α), beta (β), or gamma (γ) particles emitted from a radioactive isotope as a noise source to generate the quantum random numbers.

In another embodiment, the quantum random number generation unit may derive quantum random numbers using the following Equation (1).

$$R = α \frac{\sqrt{t + h + log ( p )}}{{( β - t )}^{2}} \qquad [ Equation 1 ]$$

(Here, R denotes a random number, t denotes temperature measured at the time the first communication device requests data processing, h denotes humidity measured at the time the first communication device requests data processing, p denotes atmospheric pressure measured at the time the first communication device requests the data processing, a denotes a first weight value, and β denotes a second weight value set according to the time the first communication device requests the data processing.)

In this way, the first quantum random number generation unit 120 may also generate random numbers using natural noise, such as the temperature, the humidity, and the atmospheric pressure.

The above Equation 1 uses the quantum random number generator that uses quantum properties to generate quantum random numbers. To this end, there is a need for a technology that captures low-energy beta-ray signals. In other words, considering the method for reducing semiconductor noise that hinders signal extraction, random numbers may be generated by using naturally occurring noise such as temperature, humidity, and atmospheric pressure.

The atmospheric pressure measured at the time of requesting the data processing from the first communication device is calculated using a logarithmic function. The logarithmic function compresses large values into a relatively smaller scale, which makes interpretation easier when properly adjusted, and allows data spanning a wide range to be viewed at a glance. Furthermore, the logarithmic function of the temperature measured at the time the first communication device requests the data processing, the humidity measured at the time the first communication device requests the data processing, and the atmospheric pressure measured at the time the first communication device requests the data processing are calculated using a root function to reduce the size of large numbers. The resulting calculated value is divided by a second weight value and by a square root of a difference with the temperature, in which this calculation process is intended to derive a random number by taking into account temperature, which is one of the most influential noise factors.

Meanwhile, the first weight value (a) described in the above-described Equation 1 may be calculated using the following Equation 2.

$$α = {\sum }_{i = 1}^{n} \frac{β ( {v}_{k} - {v}_{i} )}{{v}_{i} - {v}_{i + 1}} \qquad [ Equation 2 ]$$

(Here, a denotes the first weight value, v_k denotes an embedding vector for a word set as a keyword among words constituting data for which encryption processing has been requested from the first communication device, v_i denotes an embedding vector for an i-th word arranged among the words constituting the data for which encryption processing has been requested from the first communication device, and β denotes a second weight value described in Equation 1 described above.)

The above Equation 2 may calculate the first weight value through each result value according to a neural network that learns training data using a Word2Vec algorithm and extracts contextual information from input data, as illustrated below. This will be described below.

To understand or estimate the meaning of data, the system according to the present disclosure may construct a neural network that learns the training data using the Word2Vec algorithm and extracts the contextual information from the input data.

The Word2Vec algorithm may include a neural network language model (NNLM). The neural network language model is basically a neural network including an input layer, a projection layer, a hidden layer, and an output layer. The neural network language model is what is used to vectorize words. Since the neural network language model is a well-known technology, a detailed description thereof will be omitted.

The Word2vec algorithm is for text mining and is an algorithm that determines proximity by looking at the relationship between the front and back of each word. The Word2vec algorithm is an unsupervised learning algorithm. As the name suggests, the Word2vec algorithm may be a metric technique that expresses the meaning of a word in a vector form. The Word2vec algorithm may represent each word as a vector in a space of about 200 dimensions. Using the Word2vec algorithm, a vector corresponding to a word may be obtained for each word.

The Word2vec algorithm may dramatically improve precision in the field of natural language processing compared to other conventional algorithms. The Word2vec may learn the meaning of words by using the relationship between words in sentences of an input corpus and adjacent words. The Word2vec algorithm is based on an artificial neural network and starts from the premise that words with the same context have close meanings. The Word2vec algorithm performs training through text documents, and allows the artificial neural network to learn, as related words, other words that appear nearby (about 5 to 10 words before and after) a word. Since words with related meanings are highly likely to appear close to each other in the document, two words may gradually have close vectors in the process of repeating learning.

The learning method of the Word2vec algorithm includes a continuous bag of words (CBOW) method and a skip-gram method. The CBOW method predicts a target word using the context created by surrounding words. The skip-gram method predicts words that may come around based on one word. For large datasets, the skip-gram method is known to be more accurate.

Therefore, in the embodiment of the present invention, the Word2vec algorithm using the skip-gram method is used. For example, when the training is successfully completed through the Word2vec algorithm, similar words in a high-dimensional space may be located nearby. According to the above-described Word2vec algorithm, the calculated vector value may be similar to a word having a closer distribution of neighboring words in a learning document, and words having similar calculated vector values may be regarded as similar. Since the Word2vec algorithm is a well-known technology, a detailed description of vector value calculation will be omitted.

The server may input the collected data to the neural network to extract an evaluation result vector value representing the contextual information.

The server may calculate a similarity between the evaluation result vector value and a plurality of reference vector values, and extract a reference vector value having the highest similarity with the evaluation result vector value among the plurality of reference vector values. In this case, as a similarity calculation method, a Euclidean distance, a cosine similarity, a Tanimoto coefficient, and the like may be adopted.

The management server may extract the word corresponding to the reference vector value with the highest similarity to the evaluation result vector value as the word corresponding to the recognized text.

In addition, the management server may train the artificial neural network and use the trained artificial neural network. The processor may train or execute the artificial neural network stored in memory, and the memory may store the trained artificial neural network. The electronic device that trains the artificial neural network and the electronic device used may be the same or separate. The artificial intelligence is a computer system that partially embodies the functions of the human brain, thereby learning, inferring, and making judgments on its own. As the learning progresses, the probability of extracting an answer may increase. The artificial intelligence may be composed of learning and component technologies that utilize the learning. The AI learning is an algorithmic technology that classifies and learns features based on input data, while component technologies may be technologies of partially implementing the functions of the human brain using learning algorithms.

The AI is a technology that easily approaches problems with multiple probabilistic answers, and may logically and probabilistically infer the optimal cycle, method, plan, etc., for any input data. The AI inference technologies may include determining input data and making optimal predictions, knowledge- and probability-based inferences, and preference-based planning, etc.

The artificial neural network is one of the learning algorithms in the field of machine learning that implements the neurons and synaptic connections of the brain in a programmatic manner. The artificial neural network (ANN) may acquire desired functions by programmatically constructing the structure of the neural network and subsequently training the constructed artificial neural network. Although errors may exist, the ANN may learn from massive data and output appropriate output data based on input data. It has the advantage of obtaining statistically sound output data and being similar to human reasoning.

The server may use an AI algorithm constructed on big data to build a query/metric dataset required for learning, and for this purpose, may include multiple pre-trained ANNs.

The system according to the present disclosure may include multiple pre-trained ANNs to perform a machine learning algorithm. The machine learning may generate output data based on input data and use these results to learn on its own, thereby improving data processing capabilities on its own. The ANN may extract features from input data, infer regularities, and output result data. As this process accumulates, the reliability of the resulting data increases.

In this embodiment, the ANN may be an algorithm that outputs text data from at least one feature data, including the shape, length, number, and height difference of objects recognized as text. The ANN may either take big data directly as input or apply a preprocessing process to eliminate redundant data before using the big data as input, thereby enabling the inference of the optimal output data.

Artificial intelligence machine learning models include supervised learning, unsupervised learning, semi-supervised learning, and reinforcement learning, depending on the learning type. The machine learning algorithms that may be used include decision tree, K-nearest neighbor, artificial neural network, support vector machines, ensemble learning, gradient descent, naive Bayes classifier, hidden Markov model, K-means clustering, etc.

The ANN may be pre-trained on various input values that may be included in the input data. The ANN may be an artificial neural network trained according to the reinforcement learning, which is one of the learning methods. The reinforcement learning involves setting rewards and constraints to gradually increase the probability of obtaining a correct result. The ANN may also be modeled based on a convolutional neural network (CNN) or a recurrent neural network (RNN).

In this way, the system according to the present disclosure may estimate the meaning of text data using the big data and the ANN.

The first operation unit 130 performs a quantum security operation on the processing data requested from the first communication device using an initial seed key when the hardware-based quantum security module is called from the first communication device (200), and performs a general encryption operation.

The general encryption operation of the first operation unit 130 preferably performs the operation of the conventional cryptographic algorithm (e.g., a block cryptographic algorithm such as AES or ARIA, an asymmetric cryptographic algorithm such as ECC, a HASH function, etc.).

According to some other embodiments, the first operation unit 130 may selectively encrypt data according to a size of a security score during the general encryption process of data for which the encryption processing has been requested from the first communication device 200.

To this end, the first operation unit 130 according to an embodiment of the present disclosure calculates the security score using the following Equation (3).

$${S}_{i} = {f}_{i} \times log ( \frac{{e}_{α}}{{e}_{i}} + s + c ) \qquad [ Equation 3 ]$$

(Here, S_i denotes an encryption index calculated for chat data i, f_i denotes a feature index calculated at the time of data i's generation, e_i denotes a size of a keyword embedding vector assigned to data i, e_a denotes an average size of the keyword embedding vectors assigned to each other data categorized as data i, s denotes a setting value proportional to data capacity, and c denotes a weight value assigned to each data type.)

For example, when f_i is 3, e_i is 2, e_a is 4, s is 3, and c is 2, S_i is calculated to be approximately 2.09. The first operation unit encrypts the corresponding data (e.g., text data) only when the calculated encryption index exceeds a preset reference value (e.g., 5), and omits the data encryption when the calculated encryption index is less than or equal to the preset reference value.

The logarithmic function of the above Equation 3 initially increases rapidly, but as the value of x increases, it makes the growth rate gradually decrease, resulting in a form that changes more slowly. This is an appropriate formula for explaining the phenomenon of reaching a stable phase after rapid growth. The value may be calculated by applying the logarithmic function to the size of the embedding vector of the keyword set for data i, the average size of the embedding vectors of the keywords set for each of the other data classified in the same category as data i, a setting value proportional to the data capacity, and a weight value set for each data type.

By calculating the encryption index through the above Equation 3 and selectively performing the security operations of data according to the set security policy using the index, the resources and time required for the security operations may be reduced.

The second operation unit 140 performs the quantum security operation on the processing data requested from the first communication device using the initial seed key when the hardware-based quantum security module is called from the first communication device, and performs the general encryption operation.

The quantum encryption operation of the second operation unit 140 preferably performs a quantum-resistant cryptographic algorithm (such as ML-KEM) operation.

The algorithms and operation methods supported by the first operation unit 130 and the second operation unit 140 do not overlap, and the algorithms they support are also different from each other.

The quantum security refers to a security technology that may not be breached even by the computational power of a quantum computer utilizing the principles of quantum mechanics. The quantum security is currently divided into hardware-based quantum encryption key distribution (QKD) and software-based post-quantum cryptography (PQC). The quantum encryption key distribution (QKD) refers to a technology that utilizes no-cloning theorem and collapse of the wave function in quantum mechanics to secretly share a key (a type of random password) required for encrypted communication between two users. The quantum-resistant cryptography (PQC) may provide all the functions necessary for complete encrypted communication as well as key distribution. That is, it may provide encrypted communication in a step of randomly generating a key, which is a password, using a pseudo-random number generator (PRNG) or a quantum random number generator (QRNG), a user authentication step, a key distribution (or sharing) step, and a step of encrypting with a shared key using a secret key (symmetric key) cryptographic algorithm such as AES or SEED. In the case of the PQC, which is a public key cryptography, the encrypted communication is possible without using a secret key (symmetric key) cryptographic algorithm.

The first authentication unit 150 is for receiving user operation data and generating an authentication value.

The first authentication unit 150 receives the number of times of information leakage attempts of the first communication device 200, and when a basis code of the first communication device 200 is updated and a preset cycle associated therewith is set, a basis code may be updated according to the preset cycle within a designated range. In other words, the preset cycle may be adjusted to a modification cycle and the basis code may be updated according to the corresponding cycle, and the modification cycle is calculated by the following Equation 4.

$$B = \frac{{M}_{B}}{{M}_{avg}} {B}_{0} \qquad [ Equation 4 ]$$

(Here, B denotes the modification cycle, MB denotes the number of information leaks preset by the administrator, M_{avg} denotes the total number of information leaks of the first communication device during the preset period, and B₀ denotes the basic cycle preset by the administrator.)

For example, when the number of information leaks preset by the administrator is 7, the total number of information leaks of the first communication device during the preset period of 2 weeks is 14, and B₀ denotes the basic cycle preset by the administrator is 4 days, then the modification cycle is 2 days, and accordingly, the basis code is set to be updated every 2 days.

The first authentication unit 150 may generate a unique authentication key and a unique secret encryption key based on parameters calculated using the nonlinear hyperplane calculation formula of the linear hyperplane implemented using Equation 5. Through this, the method generates the unique authentication key and the corresponding unique secret encryption key through an operation expression in which countless random values are substituted based on the unique authentication key value, thereby ensuring the high security. Since attempting to find a unique secret encryption key corresponding to the unique authentication key would take decades, security may be enhanced by generating the unique secret encryption key through Equation 5.

$${\sum }_{j} {P}^{r} S ( {x}_{j} , {y}_{j} ) = {\sum }_{j = 1}^{z} \frac{{γ}_{j}}{\vert {x}_{j} - {y}_{j} \vert} {e}^{- \frac{1}{{q}^{2}}} \qquad [ Equation 5 ]$$

(Here, P denotes a parameter, S denotes a kernel function, γ denotes a dependent variable for the parameter, xⱼ and yⱼ denote two eigenvectors input in a vector space, and q denotes a bandwidth parameter)

The bandwidth parameter is calculated using the EXP operation. The exponential function increases gradually for small values and then significantly widens as the value increases, effectively amplifying the resultant force value.

Here, the unique authentication key may be the encryption key corresponding to the unique secret encryption key. That is, the unique authentication key and the unique secret encryption key may be encryption keys for encrypting or decrypting data according to an asymmetric key cryptographic algorithm. The asymmetric key cryptographic algorithm may vary. For example, the asymmetric key cryptographic algorithm may be any one of a Rivest, Shamir, and Adleman (RSA) algorithm, an ElGamal algorithm, an Elliptic Curve Cryptosystem (ECC) algorithm, and the DSA (SEED) algorithm. However, embodiments of the present disclosure are not limited thereto, and the unique authentication key and the unique secret encryption key may be generated using various algorithms.

The present disclosure may utilize the SVM algorithm, which is an algorithm for generating the unique authentication key and the unique secret encryption key, and constructing a hyperplane model that maximizes the margin between each class of data in a multidimensional space.

The first erasure unit 160 is for erasing the encryption key.

The first security data unit 170 is for storing the initial seed key. The first security data unit 170 may generate and store an authentication value by calculating the initial seed key and user data when the initial power is supplied. This is a procedure for mutual authentication between the hardware-based first quantum security module 100 and the first communication device 200, and is a procedure for generating an initial authentication value for future mutual authentication when two manufactured units are actually connected for the first time.

FIG. 4 is a diagram illustrating communication between the first communication unit 110 of the first quantum security module 100 of the present disclosure and the first internal communication unit 230 of a first communication device 200.

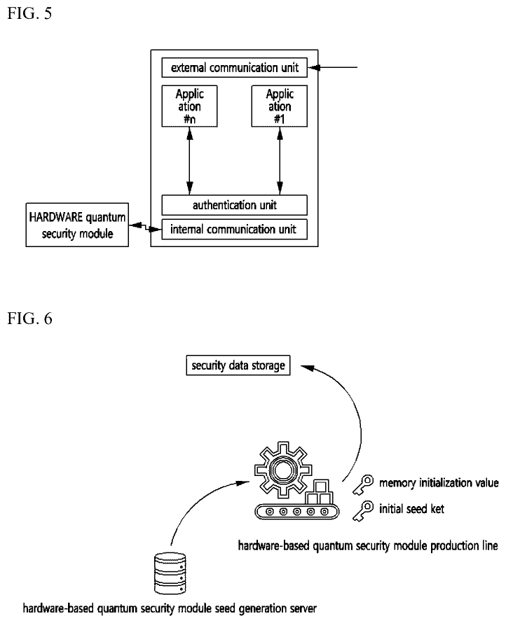

FIG. 5 is an exemplary diagram for describing communication between a quantum security module of the present disclosure and the communication device.

FIG. 6 is an exemplary diagram illustrating the generation of the seed key in the security data storage of the present disclosure. Referring to FIG. 6, the initial seed key and the memory initialization value may be provided to a hardware-based quantum security module production line via a hardware-based quantum security module seed generation server and stored in the secure data storage.

That is, the first quantum security module 100 does not have a separate power supply part and receives power from the first communication device 200. When the first quantum security module 100 receives initial power, the first quantum security module 100 generates its own seed value and stores the seed value in the security data storage.

Thereafter, when the first communication device 200 receives user data from the user of the first communication device via the network 300, which is a 5G specialized network, and transmits the user data to the first authentication unit 150 through the first device authentication unit 220 and the first internal communication unit 230 of the first communication device 200 and the first communication unit 110 of the first quantum security module 100, if the authentication value to be used later is generated, only the generated authentication value is confirmed, and the connection is immediately established.

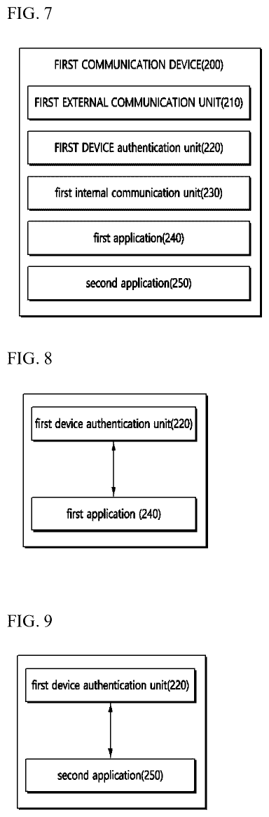

FIG. 7 is a configuration diagram of the first communication device 200 of the present disclosure, and the first communication device 200 includes a first external communication unit 210, a first device authentication unit 220, a first internal communication unit 230, a first application 240, and a second application 250. The first communication device 200 is preferably a 5G specialized communication network device. The first communication device may include a hardware processor and a memory. Each of the first external communication unit 210, the first device authentication unit 220, the first internal communication unit 230, the first application 240, and the second application 250 may be a part of the hardware processor or a software module stored in the module and executed by the hardware processor.

The first external communication unit 210 is intended to enable communication via the network 300.

The first device authentication unit 220 authenticates a user based on pre-stored user authentication information.

The first internal communication unit 230 is intended to enable communication with the first quantum security module 300.

The first application 240 is authenticated through the first quantum security module 300.

The second application 250 is authenticated through the first quantum security module 300.

FIG. 8 is an exemplary diagram of authentication between the first device authentication unit 220 and the first application 240 as an example of the first communication device 200 of the present disclosure. That is, when the first communication device 200 receives user data from the user of the first communication device via the network 300 and transmits the user data to the first authentication unit 150 through the first device authentication unit 220 and the first internal communication unit 230 of the first communication device 200 and the first communication unit 110 of the first quantum security module 100, if the authentication value to be used later is generated, only the generated authentication value is confirmed, and the connection is immediately established, enabling access to the first application 240.

FIG. 9 is an exemplary diagram of authentication between the first device authentication unit 220 and a second application 250 as an example of the first communication device 200 of the present disclosure. That is, when the first communication device 200 receives user data from the user of the first communication device via the network 300 and transmits the user data to the first authentication unit 150 through the first device authentication unit 220 and the first internal communication unit 230 of the first communication device 200 and the first communication unit 110 of the first quantum security module 100, if the authentication value to be used later is generated, only the generated authentication value is confirmed, and the connection is immediately established, enabling access to the second application 250.

Although the above embodiment only mentions the first application 240 and the second application 250, the number of applications may be in plurality.

The network 300 is intended to enable communication with the first external communication unit 210 of the first communication device 200 and the second external communication unit 510 of the second communication device 500, respectively, and may be a wireless communication such as satellite communication, 4G, 5G, 6G, WiFi, TVWS, or a wired communication such as Ethernet or serial communication.

Preferably, the network 300 is the 5G specialized network. The 5G specialized network is a customized network constructed to use the 5G network only in specific regions, buildings, factories, etc. Unlike public 5G networks, the 5G specialized network allows access to individuals or devices belonging to specific companies and provides the individuals or devices with specific services.

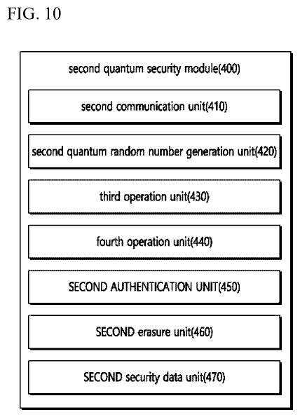

FIG. 10 is a configuration diagram of the second quantum security module 400 of the present disclosure. The second quantum security module 400 includes a second communication unit 410, a second quantum random number generation unit 420, a third operation unit 430, a fourth operation unit 440, a second authentication unit 450, a second erasure unit 460, and a second security data unit 470. The second quantum security module 400 may include a hardware processor and a memory. Each of the second communication unit 410, the second quantum random number generation unit 420, the third operation unit 430, the fourth operation unit 440, the second authentication unit 450, the second erasure unit 460, and the second security data unit 470 may be a part of the hardware processor or a software module stored in the module and executed by the hardware processor.

The second communication unit 410 is for transmitting and receiving data to and from the second communication device 500.

The second quantum random number generation unit 420 generates the quantum random numbers required in the quantum security encryption process for the quantum encryption of processing data requested from the smart device.

The third operation unit 430 performs the quantum security operation on the processing data requested from the first communication device using the initial seed key when the hardware-based quantum security module is called from the second communication device, and performs the general encryption operation to derive the user operation data.

The general encryption operation of the third operation unit 430 preferably performs the operation of the conventional cryptographic algorithm (e.g., a block cryptographic algorithm such as AES or ARIA, an asymmetric cryptographic algorithm such as ECC, a hash function, etc.).

According to some other embodiments, the first operation unit 130 may selectively encrypt data according to a size of a security score during the general encryption process of data for which the encryption processing has been requested from the first communication device 200.

The fourth operation unit 440 performs the quantum security operation on the processing data requested from the first communication device using the initial seed key when the hardware-based quantum security module is called from the second communication device, and performs the quantum encryption operation to derive the user operation data.

The quantum encryption operation of the fourth operation unit 440 preferably performs a quantum-resistant cryptographic algorithm (such as ML-KEM) operation.

The algorithms and operation methods supported by the third operation unit 430 and the fourth operation unit 440 do not overlap, and the algorithms they support are also different from each other.

The second authentication unit 450 is for receiving the user operation data and generating the authentication value.

The second erasure unit 460 is for erasing the encryption key.

The second security data unit 470 is for storing the initial seed key. The second security data unit 470 may generate and store an authentication value by calculating the initial seed key and user data when the initial power is supplied. This is a procedure for mutual authentication between the hardware-based second quantum security module 400 and the second communication device 500, and is a procedure for generating an initial authentication value for future mutual authentication when two manufactured units are actually connected for the first time.

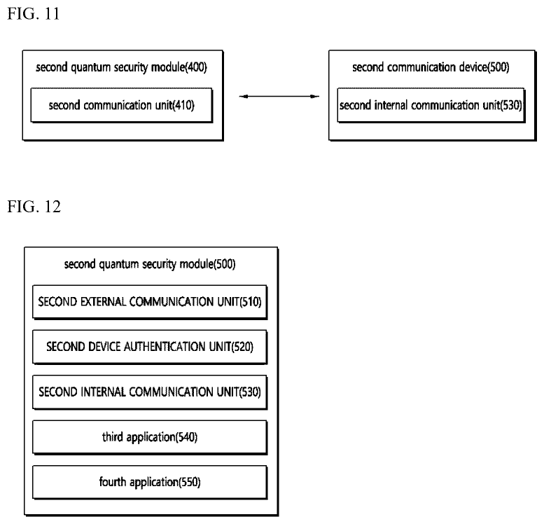

FIG. 11 is a diagram illustrating communication between the second communication unit 410 of the second quantum security module 400 of the present disclosure and the second internal communication unit 530 of a second communication device 500.

The second quantum security module 400 does not have a separate power supply part and receives power from the second communication device 500. When the second quantum security module 400 receives initial power, the second quantum security module 400 generates its own seed value and stores the seed value in the security data storage.

Thereafter, when the second communication device 500 receives user data from the user of the first communication device via the network 300, which is the 5G specialized network, and transmits the user data to the second authentication unit 450 through the second device authentication unit 520 and the second internal communication unit 530 of the second communication device 500 and the second communication unit 410 of the second quantum security module 400, if the authentication value to be used later is generated, only the generated authentication value is confirmed, and the connection is immediately established.

FIG. 12 is a configuration diagram of the second communication device 500 of the present disclosure. The second communication device 500 is configured to include a second external communication unit 510, a second device authentication unit 520, a second internal communication unit 530, a third application 540, and a fourth application 550. The second communication device 500 is preferably a 5G specialized communication network device. The second communication device 500 may include a hardware processor and a memory. Each of the second external communication unit 510, the second device authentication unit 520, the second internal communication unit 530, the third application 540, and the fourth application 550 may be a part of the hardware processor or a software module stored in the module and executed by the hardware processor.

The second external communication unit 510 is intended to enable communication via the network 300.

The second device authentication unit 520 authenticates a user based on the pre-stored user authentication information.

The second internal communication unit 530 is intended to enable communication with the second quantum security module 400.

The third application 540 is authenticated through the second quantum security module 400.

The fourth application 550 is authenticated through the second quantum security module 400.

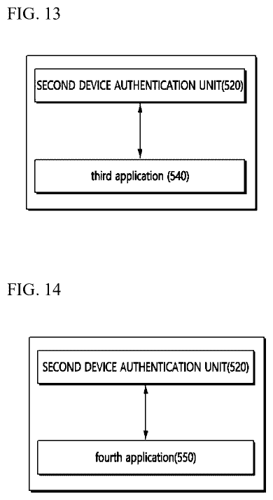

FIG. 13 is an exemplary diagram of authentication between the second authentication unit 520 and the third application 540 as an example of the second communication device 500 of the present disclosure.

That is, when the second communication device 500 receives user data from the user of the second communication device via the network 300 and transmits the user data to the second authentication unit 450 through the second device authentication unit 520 and the second internal communication unit 530 of the second communication device 500 and the second communication unit 410 of the second quantum security module 400, if the authentication value to be used later is generated, only the generated authentication value is confirmed, and the connection is immediately established, enabling access to the third application 540.

FIG. 14 is an exemplary diagram of authentication between the second authentication unit 520 and the fourth application 550 as an example of the second communication device 500 of the present disclosure. That is, when the second communication device 500 receives the user data from the user of the second communication device via the network 300 and transmits the user data to the second authentication unit 450 through the second device authentication unit 520 and the second internal communication unit 530 of the second communication device 500 and the second communication unit 410 of the second quantum security module 400, if the authentication value to be used later is generated, only the generated authentication value is confirmed, and the connection is immediately established, enabling access to the fourth application 550.

Although the above embodiment only mentions the third application 540 and the fourth application 550, the number of applications may be in plurality.

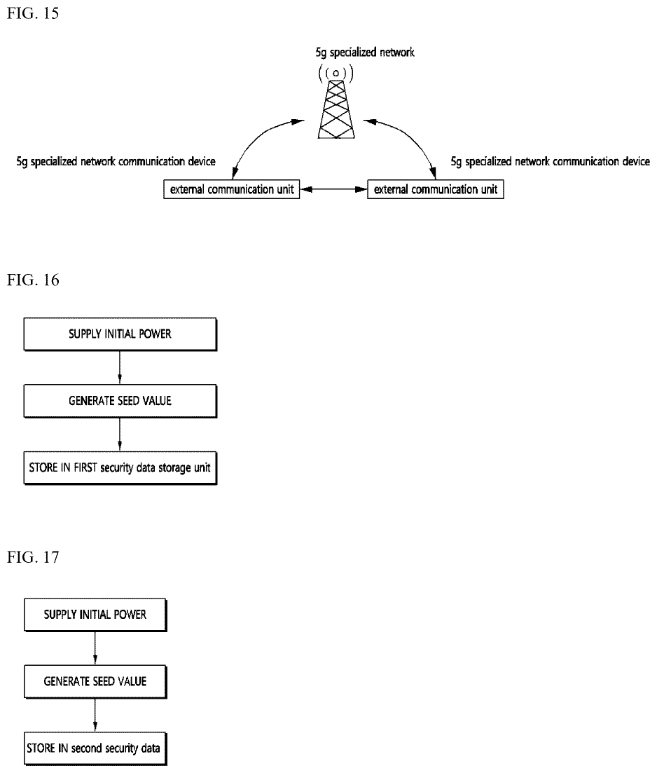

FIG. 15 is a diagram illustrating a communication state between an external communication unit and a network (5G specialized network) of the first communication device 200 of the present disclosure and a communication state between an external communication unit and a network (5G specialized network) of the second communication device 500. As illustrated in FIG. 15, the first communication device 200 and the second communication device 500 may communicate via the network 300.

FIG. 16 is a flowchart of a method for generating a seed value stored in a first security data storage unit of the present disclosure.

Referring to FIG. 16, the process is divided into a step of initially supplying power from the first communication device 200 to the first security data unit 170 of the first quantum security module 100, a step of generating a seed value, and a step of storing the seed value in the first security data unit 170.

The step of initially supplying power does not require a separate power supply part, and thus receives power from the first communication device 200.

After initial power is received, the seed value is generated for only the first quantum security module 100, and the seed value may be generated through the seed generation server of the hardware-based first quantum security module 100.

The generated seed value is stored in the first security data unit 170.

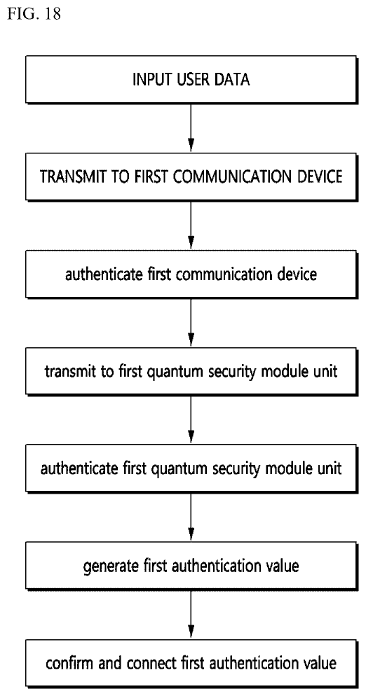

FIG. 17 is a flowchart of a method for generating a seed value stored in a second security data storage unit of the present disclosure.

Referring to FIG. 17, the process is divided into a step of initially supplying power from the second communication device 500 to the second security data unit 470 of the second quantum security module 400, a step of generating the seed value, and a step of storing the seed value in the second security data unit 470.

The step of initially supplying power does not require a separate power supply part, and thus receives power from the second communication device 500.

After the initial power is received, the seed value is generated for only the second quantum security module 400, and the seed value may be generated through the seed generation server of the hardware-based second quantum security module 400.

The generated seed value is stored in the second security data unit 470.

FIG. 18 is an exemplary flowchart for performing authentication of user data transmitted through the first communication device of the present disclosure through a quantum security module unit.

The sequence for authenticating user data transmitted through the first communication device through the quantum security module unit includes a user data input step (S11), a transmission step to the first communication device (S12), a first communication device authentication step (S13), a transmission step to the first quantum security module unit (S14), a first quantum security module unit authentication step (S15), a first authentication value generation step (S16), and a first authentication value confirmation and connection step (S17).

A description of each sequence is as follows.

### S11) User Data Input Step

The user data input step (S11) is a step of a user inputting user data for transmission to the first communication device 200.

### S12) Transmission Step to First Communication Device

The transmission step to the first communication device (S12) is a step of transmitting the user data input through the user data input step (S1) to the first communication device 200.

### S13) First Communication Device Authentication Step

The first communication device authentication step (S13) is a step for mounting the first device authentication unit 220 and the first internal communication unit 230 of the first communication device 200 to authenticate the user data.

### S14) Transmission Step to First Quantum Security Module Unit

The transmission step to the first quantum security module unit (S14) is a step of transmitting the user data from the first internal communication unit 230 of the first communication device 200 through the first communication unit 110 of the first quantum security module 100.

### S15) First Quantum Security Module Unit Authentication Step

The first quantum security module unit authentication step (S15) is a step of transmitting the user data to the first authentication unit 150 of the first quantum security module 100.

### S16) First Authentication Value Generation Step

The first authentication value generation step (S16) is a step of generating the authentication value for the user data transmitted through the first quantum security module unit authentication step (S5).

### S17) First Authentication Value Confirmation and Connection Step

The first authentication value confirmation and connection step (S17) is a step of confirming the authentication value generated through the first authentication value generation step (S6) and connecting the first communication device 200.

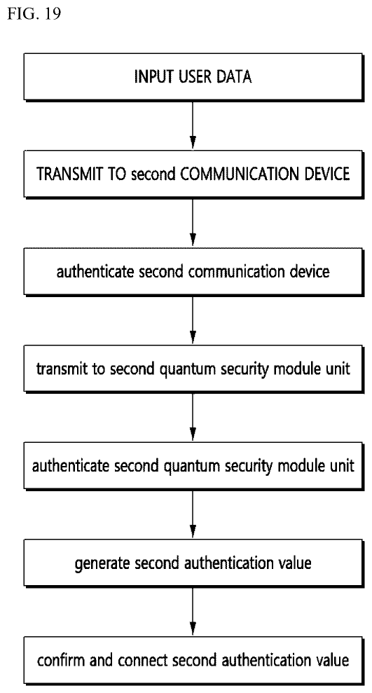

FIG. 19 is an exemplary flowchart for performing the authentication of the user data transmitted through the second communication device of the present disclosure through the quantum security module unit.

The sequence for authenticating user data transmitted through the second communication device through the quantum security module unit includes a user data input step (S21), a transmission step to the second communication device (S22), a second communication device authentication step (S23), a transmission step to the second quantum security module unit (S24), a second quantum security module unit authentication step (S25), a second authentication value generation step (S26), and a second authentication value confirmation and connection step (S27).

A description of each sequence is as follows.

### S21) User Data Input Step

The user data input step (S21) is a step in which a user inputs user data for transmission to the second communication device 500.

### S22) Transmission Step to Second Communication Device

The transmission step to the second communication device (S22) is a step in which the user data input through the user data input step (S1) is transmitted to the second communication device 500.

### S23) Second Communication Device Authentication Step

The second communication device authentication step (S23) is a step for mounting the second device authentication unit 520 and the second internal communication unit 530 of the second communication device 500 to authenticate the user data.

### S24) Transmission Step to First Quantum Security Module Unit

The transmission step to the first quantum security module unit (S24) is a step of transmitting the user data from the second internal communication unit 530 of the second communication device 500 through the second communication unit 410 of the second quantum security module 400.

### S25) Second Quantum Security Module Unit Authentication Step

The second quantum security module unit authentication step (S25) is a step of transmitting the user data to the second authentication unit 450 of the second quantum security module 400.

### S26) Second Authentication Value Generation Step

The second authentication value generation step (S26) is a step of generating the authentication value for the user data transmitted through the second quantum security module unit authentication step (S25).

### S27) Second Authentication Value Confirmation and Connection Step

The second authentication value confirmation and connection step (S27) is a step of confirming the authentication value generated through the second authentication value generation step (S26) and connecting the second communication device 500.

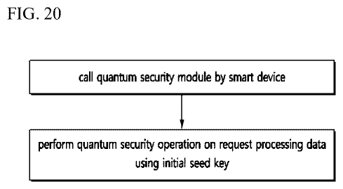

FIG. 20 is an exemplary flowchart for performing a quantum security operation of the present disclosure.

Referring to FIG. 20, the first quantum security module 100 is called from the first communication device 200, or the second quantum security module 400 is called from the second communication device 500.

Next, the quantum security operation is performed on the request processing data using the initial seed keys of each of the first quantum security module 100 and the second quantum security module 400.

In summary, the present disclosure includes the following steps.
1. Mutual authentication step between the communication device and the hardware quantum security module

Injecting the initial seed key into the security data storage during the hardware quantum security module production.

When the initial power is supplied, the authentication value is generated and stored in the security data storage by calculating the initial seed value in the security data storage with the user data input through the authentication unit.
2. Step of calling the hardware quantum security module from the application.
3. Step of operating the hardware quantum security module function (general operation function and quantum cryptographic operation function).
4. Step of initializing the hardware quantum security module security data storage data and locking up the authentication unit when transmitting an initial memory signal.

As described above, the technology according to the present invention may be implemented as an application or implemented in the form of program instructions that may be executed through various computer components and recorded on a computer-readable recording medium. The computer-readable recording medium may include program commands, data files, data structures, or the like, alone or in combination.

The program commands recorded in the computer-readable recording medium may be especially designed and constituted for the present invention or be known to those skilled in a field of computer software.

Example of the computer-readable recording medium may include a magnetic medium such as a hard disk, a floppy disk, and a magnetic tape; an optical recording medium such as a CD-ROM, a DVD; a magneto-optical medium such as a floptical disk; and a hardware device specially configured to store and perform program commands such as a ROM, a RAM, a flash memory, or the like.

Examples of the program commands include a high-level language code capable of being executed by a computer using an interpreter, or the like, as well as a machine language code made by a compiler. The above-described hardware device may be constituted to be operated as one or more software modules to perform processing according to the present disclosure, and vice versa.

According to one aspect of the present disclosure described above, it is possible to prevent security vulnerabilities that may arise during communication by using the quantum random numbers generated by the first quantum random number generation unit and the second quantum random number generation unit, and by allowing the communication unit to encrypt the user communication data based on the authentication value generated by the quantum security module, it is possible to implement the safe data transmission.

Furthermore, by allowing the communication module to verify the devices and the user authentication information in real time according to the setting of the terminal, it is possible to prevent the data leakage and unauthorized access on the network.

As described above, although the embodiments have been described by the limited drawings, various modifications and alternations are possible by those of ordinary skill in the art from the above description. For example, even though the described techniques may be performed in a different order than the described method, and/or components of the described systems, structures, devices, circuits, etc. may be combined or combined in a different manner than the described method, or replaced or substituted by other components, appropriate results may be achieved.

Therefore, other implementations, other embodiments, and equivalents of the claims are within the scope of the following claims.

What is claimed is:

1. A quantum random number-based security management device for a mobile terminal, comprising:
a first quantum security module (100) connected to a first communication device (200) and configured to support encrypted security communication of the first communication device (200);
the first communication device (200); and
a network (300) configured to transmit user data input from the first communication device (200) to the first quantum security module (100),
wherein the first quantum security module (100) comprises:
a first communication unit (110) configured to transmit and receive data with the first communication device (200);
a first quantum random number generator (120) configured to generate a quantum random number required in a quantum security encryption process for quantum encryption of processing data requested by the first communication device (200); and
wherein the first operation unit (130) selectively encrypts data according to a magnitude of an encryption index in a general encryption process of data for which the first communication device (200) requests encryption processing,
wherein the encryption index is calculated based on a characteristic index calculated at the time of data generation, a magnitude value of an embedding vector of a keyword set for the data, an average magnitude value of embedding vectors of keywords set for other data classified into the same category as the data, and a set value proportional to a data size, and
wherein the first operation unit (130) performs a security task selectively according to a security policy set by using the calculated encryption index.

2. The quantum random number-based security management device for a mobile terminal according to claim 1,
wherein the first quantum security module (100) further comprises:
a second operation unit (140) configured to perform a quantum encryption operation on the processing data requested by the first communication device (200) using the initial seed key upon calling of the hardware quantum security module from the first communication device (200);
a first authentication unit (150) configured to receive user operation data and generate an authentication value;
a first erasure unit (160) configured to erase an encryption key; and
a first security data unit (170) configured to store the initial seed key,
wherein the first authentication unit (150) receives the number of attempts of information leakage of the first communication device (200), and when a preset cycle related to updating of a basis code of the first communication device (200) is set, the basis code is updated according to the preset cycle within a designated range,
wherein the preset cycle is adjusted to a modified cycle, and the basis code is updated according to the modified cycle, and
wherein the modified cycle is calculated by using a preset reference number of information leakage attempts set by an administrator, a total number of information leakage attempts of the first communication device during a preset period, and a basic cycle preset by the administrator.

3. The quantum random number-based security management device for a mobile terminal according to claim 2,
wherein the first communication device (200) comprises:
a first external communication unit (210) configured to enable communication through the network (300);
a first device authentication unit (220) configured to authenticate a user based on pre-stored user authentication information;
a first internal communication unit (230) configured to enable communication with the first quantum security module (100); and
a first application (240) configured to be authenticated through the first quantum security module (100).

4. The quantum random number-based security management device for a mobile terminal according to claim 2,
wherein the first quantum random number generator (120) is implemented in a form of a chip, and generates a quantum random number by processing an encryption algorithm using alpha (α), beta (β), or gamma (γ) particles emitted from a radioactive isotope as a noise source.

5. The quantum random number-based security management device for a mobile terminal according to claim 4,
wherein the first quantum random number generator (120) is configured to calculate the quantum random number by setting, as variables, environmental information measured at a time point when data processing is requested by the first communication device and information regarding the time point when data processing is requested by the first communication device, and by performing an operation on the set variables.

6. A quantum random number-based security management device for a mobile terminal, comprising:
a first quantum security module (100) connected to a first communication device (200) and configured to support encrypted security communication of the first communication device (200);
the first communication device (200);
a network (300) configured to transmit user data input from the first communication device (200) to the first quantum security module (100) and to transmit user data input from a second communication device (500) to a second quantum security module (400);
the second quantum security module (400) configured to support encrypted security communication of the second communication device (500); and
the second communication device (500),
wherein the first quantum security module (100) comprises:
a first communication unit (110) configured to transmit and receive data with the first communication device (200);
a first quantum random number generator (120) configured to generate a quantum random number required in a quantum security encryption process for quantum encryption of processing data requested by the first communication device (200); and
a first operation unit (130) configured to perform a quantum security operation on the processing data requested by the first communication device (200) by using an initial seed key upon calling of a hardware quantum security module from the first communication device (200), and configured to perform a general encryption operation,
wherein the first operation unit (130) selectively encrypts data according to a magnitude of an encryption index in a general encryption process of data for which the first communication device (200) requests encryption processing,
wherein the encryption index is calculated based on a characteristic index calculated at a time of data generation, a magnitude value of an embedding vector of a keyword set for the data, an average magnitude value of embedding vectors of keywords set for other data classified in the same category as the data, and a set value proportional to a data size, and
wherein the first operation unit (130) performs a security task selectively according to a set security policy by using the calculated encryption index.

7. The quantum random number-based security management device for a mobile terminal according to claim 6,
wherein the first quantum security module (100) further comprises:
a second operation unit (140) configured to perform a quantum encryption operation on processing data requested by the first communication device (200) using the initial seed key upon calling of the hardware quantum security module from the first communication device (200);
a first authentication unit (150) configured to receive user operation data and generate an authentication value; and
a first security data unit (170) configured to store the initial seed key,
wherein the first quantum random number generator (120) is configured to calculate a quantum random number by setting, as variables, environmental information measured at a time when data processing is requested by the first communication device (200) and information regarding the time when data processing is requested by the first communication device (200), and by performing an operation on the set variables, and
wherein the first authentication unit (150) receives the number of information leakage attempts of the first communication device (200), and when a preset cycle related to updating of a basis code of the first communication device (200) is set, the basis code is updated according to the preset cycle within a designated range, the preset cycle is adjusted to a modified cycle, and the basis code is updated according to the modified cycle,
wherein the modified cycle is calculated by using a preset reference number of information leakage attempts set by an administrator, a total number of information leakage attempts of the first communication device during a preset period of time, and a basic cycle preset by the administrator.

8. The quantum random number-based security management device for a mobile terminal according to claim 7,
wherein the first communication device (200) comprises:
a first external communication unit (210) configured to enable communication through the network (300);
a first device authentication unit (220) configured to authenticate a user based on pre-stored user authentication information;
a first internal communication unit (230) configured to enable communication with the first quantum security module (300); and
a first application (240) configured to be authenticated through the first quantum security module (300).

9. The quantum random number-based security management device for a mobile terminal according to claim 7,
wherein the first quantum random number generator (120) is implemented in a form of a chip and generates a quantum random number by processing an encryption algorithm using alpha (α), beta (β), or gamma (γ) particles emitted from a radioactive isotope as a noise source.

10. The quantum random number-based security management device for a mobile terminal according to claim 9,
wherein the quantum random number is proportional to a sum of a temperature measured at a time when the first communication device requests data processing, a humidity measured at the time when the first communication device requests data processing, and an atmospheric pressure measured at the time when the first communication device requests data processing.

11. A quantum random number-based security management method for a mobile terminal, comprising:
a transmission step (S12) of transmitting input user data to a first communication device (200);
a first communication device authentication step (S13) of passing through a first device authentication unit (220) and a first internal communication unit (230) included in the first communication device (200) for authentication of the user data;
a first quantum security module transmission step (S14) of transmitting the user data from the first internal communication unit (230) included in the first communication device (200) to a first communication unit (110) of a first quantum security module (100);
a first quantum security module authentication step (S15) of transmitting the user data to a first authentication unit (150) included in the first quantum security module (100);
a first authentication value generation step (S16) of generating an authentication value for the user data transmitted through the first quantum security module authentication step (S15); and
a first authentication value confirmation and connection step (S17) of confirming the authentication value generated through the first authentication value generation step (S16) and connecting the first communication device (200),
wherein the first quantum security module (100) comprises:
a first communication unit (110) configured to transmit and receive data with the first communication device (200);
a first quantum random number generator (120) configured to generate a quantum random number required in a quantum security encryption process for quantum encryption of processing data requested by the first communication device (200); and
a first operation unit (130) configured to perform a quantum security operation on the processing data requested by the first communication device (200) by using an initial seed key upon calling of a hardware quantum security module from the first communication device (200), and configured to perform a general encryption operation,
wherein the first operation unit (130) selectively encrypts data according to a magnitude of an encryption index in a general encryption process of data for which the first communication device (200) requests encryption processing,
wherein the encryption index is calculated based on a characteristic index calculated at a time of data generation, a magnitude value of an embedding vector of a keyword set for the data, an average magnitude value of embedding vectors of keywords set for other data classified in the same category as the data, and a set value proportional to a data size, and
wherein the first operation unit (130) performs a security task selectively according to a set security policy by using the calculated encryption index.

12. The quantum random number-based security management method for a mobile terminal according to claim 11,
wherein the first quantum security module (100) further comprises:
a second operation unit (140) configured to perform a quantum encryption operation on the processing data requested by the first communication device (200) using the initial seed key upon calling of the hardware quantum security module from the first communication device (200);
a first authentication unit (150) configured to receive user operation data and generate an authentication value;
a first erasure unit (160) configured to erase an encryption key; and
a first security data unit (170) configured to store the initial seed key,
wherein the first authentication unit (150) receives the number of information leakage attempts of the first communication device (200), and when a preset cycle related to updating of a basis code of the first communication device (200) is set, the basis code is updated according to the preset cycle within a designated range,
wherein the preset cycle is adjusted to a modified cycle, and the basis code is updated according to the modified cycle, and
wherein the modified cycle is calculated by using a preset reference number of information leakage attempts set by an administrator, a total number of information leakage attempts of the first communication device (200) during a preset period of time, and a basic cycle preset by the administrator.

13. A method for generating a seed value stored in a security data storage unit of a quantum random number-based security management device for a mobile terminal, the method comprising:
a step of receiving power supplied from a first communication device (200);
a step of generating a seed value of only a first quantum security module (100) after initial power supply, wherein the seed value is generated through a seed generation server of the hardware-based first quantum security module (100); and
a step of storing the generated seed value in a first security data storage unit (170) included in the first quantum security module (100),
wherein the first quantum security module (100) comprises:
a first communication unit (110) configured to transmit and receive data with the first communication device (200);
a first quantum random number generator (120) configured to generate a quantum random number required in a quantum security encryption process for quantum encryption of processing data requested by the first communication device (200); and
a first operation unit (130) configured to perform a quantum security operation on the processing data requested by the first communication device (200) by using an initial seed key upon calling of a hardware quantum security module from the first communication device (200), and configured to perform a general encryption operation,
wherein the first operation unit (130) selectively encrypts data according to a magnitude of an encryption index in a general encryption process of data for which the first communication device (200) requests encryption processing,
wherein the encryption index is calculated based on a characteristic index calculated at a time of data generation, a magnitude value of an embedding vector of a keyword set for the data, an average magnitude value of embedding vectors of keywords set for other data classified in the same category as the data, and a set value proportional to a data size, and
wherein the first operation unit (130) performs a security task selectively according to a set security policy by using the calculated encryption index.

14. The method for generating a seed value stored in a security data storage unit according to claim 13,
wherein the first quantum security module (100) further comprises:
a second operation unit (140) configured to perform a quantum encryption operation on the processing data requested by the first communication device (200) using the initial seed key upon calling of the hardware quantum security module from the first communication device (200);
a first authentication unit (150) configured to receive user operation data and generate an authentication value;
a first erasure unit (160) configured to erase an encryption key; and
a first security data unit (170) configured to store the initial seed key,
wherein the first authentication unit (150) receives the number of information leakage attempts of the first communication device (200), and when a preset cycle related to updating of a basis code of the first communication device (200) is set, the basis code is updated according to the preset cycle within a designated range,
wherein the preset cycle is adjusted to a modified cycle and the basis code is updated according to the modified cycle, and
wherein the modified cycle is calculated by using a preset reference number of information leakage attempts set by an administrator, a total number of information leakage attempts of the first communication device during a preset period of time, and a basic cycle preset by the administrator.
